(19) United States
(12) Patent Application Publication
(10) Pub. No.: US 2008/0266286 A1
(43) Pub. Date: Oct. 30, 2008

(54) GENERATION OF A PARTICLE SYSTEM USING A GEOMETRY SHADER

(75) Inventors: William Orville Ramey, Santa Clara, CA (US); Henry Packard Moreton, Woodside, CA (US); Douglas H. Rogers, Gilroy, CA (US)

Correspondence Address: TOWNSEND AND TOWNSEND AND CREW LLP, TWO EMBARCADERO CENTER, 8TH FLOOR, SAN FRANCISCO, CA, 94111-3834, US

(73) Assignee: NVIDIA Corporation, Santa Clara, CA (US)

(21) Appl. No.: 11/740,009

(22) Filed: Apr. 25, 2007

(51) Int. Cl. G06T 15/00

(52) U.S. Cl. 345/419

(57) ABSTRACT

A geometry shader of a graphics processor is configured to generate at least a portion of a particle system. The geometry shader receives vertex data including a reference set of vertices. The geometry shader also receives control data including information on how to create additional vertices for the particle system using the vertex data. The geometry shader processes the vertex data and control data to generate the additional vertices for the particle system. In some embodiments, the control data also includes information on other attributes of the generated vertices.

### BACKGROUND OF THE INVENTION

The present invention relates in general to computer graphics, and in particular to the generation of a particle system in a graphics processor.

Many computer generated images are created by mathematically modeling the interaction of light with a three-dimensional (3D) scene from a given viewpoint and projecting the result onto a two-dimensional (2D) “screen.” This process, called rendering, generates a 2D image of the scene from the given viewpoint and is analogous to taking a digital photograph of a real-world scene.

Certain traditional modeling techniques are often better at creating objects with well-defined surfaces. However, objects without such definition, such as fire, an explosion, smoke, clouds, fog, mist, rain, snow and other “fuzzy” objects present challenges. In computer graphics, these objects may be rendered using a technique referred to as a particle system. In a particle system, a fuzzy object is modeled as a group of particles with certain attributes, and often some algorithm or random element that defines the behavior of the particles.

As the demand for computer graphics, and in particular for real-time computer graphics, has increased, computer systems with graphics processing subsystems adapted to accelerate the rendering process have become widespread. In these computer systems, the rendering process is often divided between a computer's general-purpose central processing unit (CPU) and a graphics processing subsystem. Often, the CPU performs high-level operations, such as determining the position, motion, and collisions for the particles of a particle system, and other objects in a given scene. From these high-level operations, the CPU generates a set of rendering commands and data defining the desired rendered image (or images). For example, rendering commands and data from the CPU may identify groups of vertices that define scene geometry (e.g., of particle systems and other objects). Each vertex or set of vertices may have associated attributes such as color, world space coordinates, texture-map coordinates, and the like. Rendering commands and data can also define other parameters for a scene, such as lighting, shading, textures, motion, and/or camera position. From the set of rendering commands and data, the graphics processing subsystem creates one or more rendered images.

Graphics processing subsystems typically use a stream, or pipeline, processing model, in which input elements are read and operated on successively by a chain of processing units. The output of one processing unit is the input to the next processing unit in the chain. A typical pipeline includes a number of processing units, which compute attribute values for the received vertices, create parameterized attribute equations, and determine which particular pixels or sub-pixels are covered by a given set of particles or other object. Typically, data flows one way, “downstream,” through the chain of units, although some processing units may be operable in a “multi-pass” mode, in which data that has already been processed by a given processing unit can be returned to that unit for additional processing.

The data sent to the graphics processing subsystem typically includes a set of vertices, for a given set of particles or other object, to be used in rendering the final image. However, sending the entire set of vertices to be rendered may be a strain on bandwidth available between a CPU/system memory and the GPU. Many computer graphics applications make use of increasingly advanced particle systems. As particle systems become more complex, they may include a larger number of vertices. Processing bottlenecks can occur, for instance, if the graphics subsystem does not provide sufficient bandwidth to communicate all of the vertices and their associated attributes through various units of the pipeline.

It may, therefore, be desirable to send condensed vertex data through select parts of the graphics pipeline in order to decrease excess rendering operations, reduce the bandwidth requirements for communicating vertices for a particle system, and improve rendering performance.

### BRIEF SUMMARY OF THE INVENTION

Embodiments of the present invention provide for methods and devices for generating at least a portion of a particle system. A geometry shader of a graphics processor is configured to receive vertex data including a number of vertices representative of a control mesh. The geometry shader also receives control data with the vertex data, the control data including information on how to create additional vertices using the vertex data. The geometry shader processes the vertex data and control data to generate the additional vertices for a particle system. The particle system may be used, for example, to illustrate fire, an explosion, smoke, a waterfall, flowing water, blood, other liquid, sparks, falling leaves, a tree, a flock, clouds, fog, mist, rain, snow, dust, or other fuzzy objects. In some embodiments, the control data also includes information on other attributes of the additional vertices.

In one set of embodiments, a graphics processor includes a geometry shader directly, or indirectly, connected with one or more upstream processing units. The upstream processing unit may, for example, be a vertex shader. Vertex data for a first set of vertices is passed from the upstream processing unit to the geometry shader. This first set of vertices may be referred to hereinafter as the “reference set” of vertices. The geometry shader also receives control data including rules which identify positions of additional vertices relative to one or more of the first set of vertices. The geometry shader generates the additional vertices using the vertex data and the control data, thereby creating or otherwise enhancing a particle system. In one embodiment, the upstream processing unit is configured to pass the control data to the geometry shader with per-vertex texture data.

In some embodiments, the control data includes additional attribute information for the generated vertices. The geometry shader associates attributes identified in the attribute information with one or more of the generated vertices. The additional attribute information may, for example, include velocity data indicating a speed and direction attributed to one or more generated vertices. In alternative embodiments, the attribute information may include color, age, life cycle, transparency, mass, energy, size, shape, previous position, or particle density data for one or more of the generated vertices. In one embodiment, the attribute information identifies attributes varying with age of the generated vertices. The geometry shader in that embodiment is configured to identify attributes from the control data based at least in part on the age associated with the generated vertices.

The geometry shader may, therefore, be configured to compute attributes for the generated vertices using the control data. These attributes may vary depending on a time related metric. In one embodiment, the geometry shader calculates an effect of a collision between an object in a scene to be rendered and particles associated with the generated vertices, and modifies the position of the generated vertices to reflect the collision.

In one embodiment, the reference set of vertices is a primitive in a first shape, while the generated vertices for at least one of a set of points, lines, triangles, quadrilaterals, or other polygons are a second shape which is different than the first shape. In some embodiments, the reference set may be a part of the particle system, although in other embodiments, the reference set may not be visible.

In another set of embodiments, a graphics processor includes a geometry shader and a vertex shader. The vertex shader may be directly, or indirectly, connected with a geometry shader, and receive vertex data for a reference set of vertices. The vertex shader also receives control data including rules associated with generating additional vertices for a particle system using the first set of vertices. The vertex shader forwards the vertex data and the control data to the geometry shader. The geometry shader processes the vertex data and the control data to create at least part of a particle system. In one embodiment, the control data includes rules for identifying positions of the additional vertices relative to one or more of the reference set of vertices. In another embodiment, the control data includes velocity attributes of the additional vertices.

In another set of embodiments, a method of processing vertex data to generate at least part of a particle system is described. Vertex data for a reference set of vertices is received. Control data is also received, the control data including rules to identify positions of additional vertices relative to one or more of the reference set of vertices. The vertex data and control data may, for example, be received by a geometry shader from a vertex shader or other upstream processing unit of a graphics processor. The geometry shader processes the vertex data and control data to generate the additional vertices to form at least a part of a particle system.

In one embodiment, additional attribute information for the generated vertices is included in the control data. Attributes for the generated vertices are computed in the geometry shader using the additional attribute information. In one embodiment, control data is generated including the rules and the attribute information, and the control data is forwarded to the geometry shader for processing. The control data may be integrated with per-vertex texture data before being passed to the geometry shader for processing. It is worth noting that in some embodiments, the particle system may be rendered while the reference set of vertices are invisible in the rendered scene.

### BRIEF DESCRIPTION OF THE DRAWINGS

A further understanding of the nature and advantages of the present invention may be realized by reference to the following drawings. In the appended figures, similar components or features may have the same reference label. Further, various components of the same type may be distinguished by following the reference label by a dash and a second label that distinguishes among the similar components. If only the first reference label is used in the specification, the description is applicable to any one of the similar components having the same first reference label irrespective of the second reference label.

FIG. 1 is a block diagram of a computer system configured according to various embodiments of the present invention;

FIG. 2 is a block diagram of a rendering pipeline of a graphics processing subsystem configured according to various embodiments of the present invention;

FIG. 3 is a block diagram of a multithreaded core array configured according to various embodiments of the present invention;

FIG. 4 is a block diagram illustrating shader units of a rendering pipeline configured according to various embodiments of the present invention;

FIGS. 5A-B illustrate the generation of vertices using a reference set of vertices according to various embodiments of the present invention;

FIGS. 6A-B is alternative illustration of the generation of vertices using a reference set of vertices according to various embodiments of the present invention;

FIGS. 7A-C illustrate various references sets of vertices, and the generation of additional vertices according to various embodiments of the present invention;

FIG. 8 is a flowchart illustrating a method of processing data using a geometry shader to generate vertices for a particle system according to various embodiments of the present invention;

FIG. 9 is a flowchart illustrating a method of computing additional vertices and attributes for a particle system using a geometry shader according to various embodiments of the present invention; and

FIG. 10 is a flowchart illustrating an alternative method of computing additional vertices and attributes for a particle system using a geometry shader according to various embodiments of the present invention.

### DETAILED DESCRIPTION OF THE INVENTION

This description provides exemplary embodiments only, and is not intended to limit the scope, applicability or configuration of the invention. Rather, the ensuing description of the embodiments will provide those skilled in the art with an enabling description for implementing embodiments of the invention. Various changes may be made in the function and arrangement of elements without departing from the spirit and scope of the invention as set forth in the appended claims.

Thus, various embodiments may omit, substitute, or add various procedures or components as appropriate. For instance, it should be appreciated that in alternative embodiments, the methods may be performed in an order different than that described, and that various steps may be added, omitted or combined. Also, features described with respect to certain embodiments may be combined in various other embodiments.

It should also be appreciated that the following systems, methods, and software may be a component of a larger system, wherein other procedures may take precedence over or otherwise modify their application. Also, a number of steps may be required before, after, or concurrently with the following embodiments.

According to various embodiments of the invention, a processing engine of a graphics processor utilizes a set of vertex data and control data to generate additional vertices for a particle system. The processing engine receives vertex data including a reference set of vertices. The processing engine also receives control data including information on how to create additional vertices using the vertex data. The processing engine processes the vertex data and control data to generate additional vertices for a particle system.

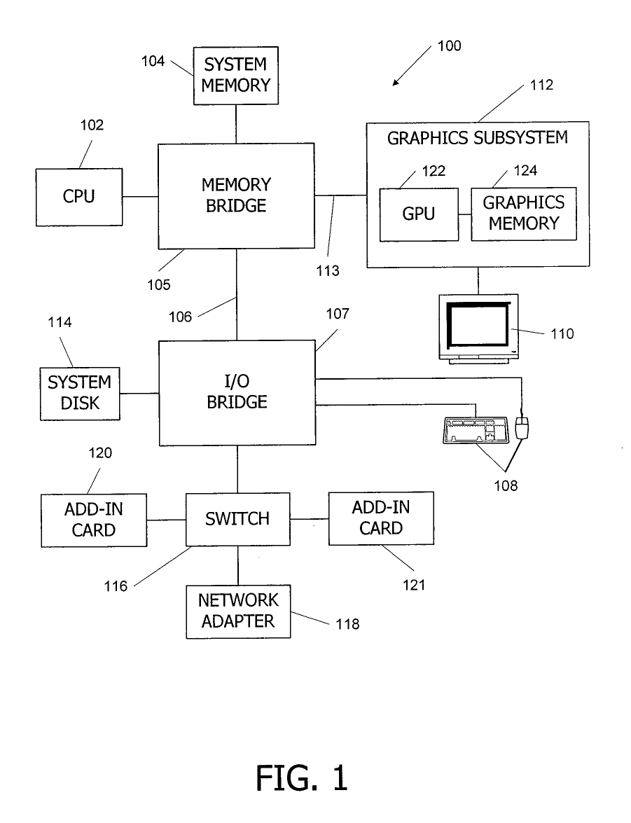

FIG. 1 is a block diagram of a computer system 100 according to one embodiment of the present invention. Computer system 100 includes a central processing unit (CPU) 102 and a system memory 104 communicating via a bus path that includes a memory bridge 105. Memory bridge 105, which may be, e.g., a conventional Northbridge chip, is connected via a bus or other communication path 106 (e.g., a HyperTransport link) to an I/O (input/output) bridge 107. I/O bridge 107, which may be, e.g., a conventional Southbridge chip, receives user input from one or more user input devices 108 (e.g., keyboard, mouse) and forwards the input to CPU 102 via bus 106 and memory bridge 105. Visual output is provided on a pixel based display device 110 (e.g., a conventional CRT or LCD based monitor) operating under control of a graphics subsystem 112 coupled to memory bridge 105 via a bus or other communication path 113, e.g., a PCI Express (PCI-E) or Accelerated Graphics Port (AGP) link. A system disk 114 is also connected to I/O bridge 107. A switch 116 provides connections between I/O bridge 107 and other components such as a network adapter 118 and various add-in cards 120, 121. Other components (not explicitly shown), including USB or other port connections, CD drives, DVD drives, and the like, may also be connected to I/O bridge 107. Bus connections among the various components may be implemented using bus protocols such as PCI (Peripheral Component Interconnect), PCI-E, AGP, HyperTransport, or any other bus or point-to-point communication protocol(s), and connections between different devices may use different protocols as known in the art.

Graphics processing subsystem 112 includes a graphics processing unit (GPU) 122 and a graphics memory 124, which may be implemented, e.g., using one or more integrated circuit devices such as programmable processors, application specific integrated circuits (ASICs), and memory devices. GPU 122 may be configured to perform various tasks related to generating pixel data from graphics data supplied by CPU 102 and/or system memory 104 via memory bridge 105 and bus 113, interacting with graphics memory 124 to store and update pixel data, and the like. For example, GPU 122 may generate pixel data from 2-D or 3-D scene data provided by various programs executing on CPU 102. GPU 122 may also store pixel data received via memory bridge 105 to graphics memory 124 with or without further processing. GPU 122 also includes a scanout module configured to deliver pixel data from graphics memory 124 to display device 110.

CPU 102 operates as the master processor of system 100, controlling and coordinating operations of other system components. In particular, CPU 102 issues commands that control the operation of GPU 122. In some embodiments, CPU 102 writes a stream of commands for GPU 122 to a command buffer, which may be in system memory 104, graphics memory 124, or another storage location accessible to both CPU 102 and GPU 122. GPU 122 reads the command stream from the command buffer and executes commands asynchronously with operation of CPU 102. The commands may include conventional rendering commands for generating images as well as general-purpose computation commands that enable applications executing on CPU 102 to leverage the computational power of GPU 122 for data processing that may be unrelated to image generation.

In one embodiment, CPU 102 executes one or more programs to create a control mesh defined by a reference set of vertices, along with control data to be used to generate additional vertices for a particle system relative to the control mesh (or one or more vertices therein). The particle system may be used, for example, to illustrate fire, an explosion, smoke, a waterfall, flowing water, blood, other liquid, sparks, falling leaves, a tree, a flock, clouds, fog, mist, rain, snow, dust, or other fuzzy objects. The computer system 100 may receive or otherwise produce data to implement a particle system. As noted above, many computer graphics applications implement complex particle systems, which may have significant computational costs. For a given particle system, CPU 102 may identify or otherwise create a reference set of vertices. The reference set may be subset, or an otherwise reduced set, of vertices from a larger set of vertices to be produced for a particle system. The CPU 102 may create or otherwise identify vertex data for this reference set of vertices, and forward this vertex data to the rendering pipeline of GPU 122.

In conjunction with the creation or identification of the vertex data, CPU 102 may execute a program to create a set of control data, with rules to identify positions of additional vertices relative to one or more of the reference set of vertices. The control data may be included with or otherwise integrated into per-vertex attributes (e.g., the per-vertex texture attributes). The control data may also include additional attribute information for the additional vertices. The additional attribute information may, for example, include velocity data indicating a speed and direction attributed to one or more generated vertices. The attribute information may also include color, age, life cycle, transparency, mass, energy, size, shape, previous position or particle density data for one or more of the additional vertices. Any part of the control data may be applied to certain subsets of the set of vertices, or may be applied on a per-vertex basis. Attributes of the additional vertices may vary over time, and the control data may be configured to be reused over a series of frames. The control data may include a stochastic process causing random fluctuations of the position and other attributes of the additional vertices (e.g., over time). The control data may also be used to interpolate specific values for vertices created in the geometry shader. CPU 102 may forward this control data to the rendering pipeline of the GPU 122.

Also, it is worth noting that any combination of the vertex data and control data may be received via the network adapter 118, or otherwise, from an external computing device local or remote to the system. In one embodiment, the creation or identification of the vertex data and/or control data may be executed, in whole or in part, by the GPU 122.

It will be appreciated that the system shown herein is illustrative and that variations and modifications are possible. The bus topology, including the number and arrangement of bridges, may be modified as desired. For instance, in some embodiments, system memory 104 is connected to CPU 102 directly rather than through a bridge, and other devices communicate with system memory 104 via memory bridge 105 and CPU 102. In other alternative topologies, graphics subsystem 112 is connected to I/O bridge 107 rather than to memory bridge 105. In still other embodiments, I/O bridge 107 and memory bridge 105 might be integrated into a single chip. The particular components shown herein are optional; for instance, any number of add-in cards or peripheral devices might be supported. In some embodiments, switch 116 is eliminated, and network adapter 118 and add-in cards 120, 121 connect directly to I/O bridge 107.

The connection of GPU 122 to the rest of system 100 may also be varied. In some embodiments, graphics system 112 is implemented as an add-in card that can be inserted into an expansion slot of system 100. In other embodiments, a GPU is integrated on a single chip with a bus bridge, such as memory bridge 105 or I/O bridge 107. In still other embodiments, some or all elements of GPU 122 may be integrated with CPU 102.

A GPU may be provided with any amount of local graphics memory, including no local memory, and may use local memory and system memory in any combination. For instance, in a unified memory architecture (UMA) embodiment, no dedicated graphics memory device is provided, and the GPU uses system memory exclusively or almost exclusively. In UMA embodiments, the GPU may be integrated into a bus bridge chip or provided as a discrete chip with a high-speed bus (e.g., PCI-E) connecting the GPU to the bridge chip and system memory.

It is also to be understood that any number of GPUs may be included in a system, e.g., by including multiple GPUs on a single graphics card or by connecting multiple graphics cards to bus 113. Multiple GPUs may be operated in parallel to generate images for the same display device or for different display devices.

In addition, GPUs embodying aspects of the present invention may be incorporated into a variety of devices, including general purpose computer systems, video game consoles and other special purpose computer systems, DVD players, handheld devices such as mobile phones or personal digital assistants, and so on.

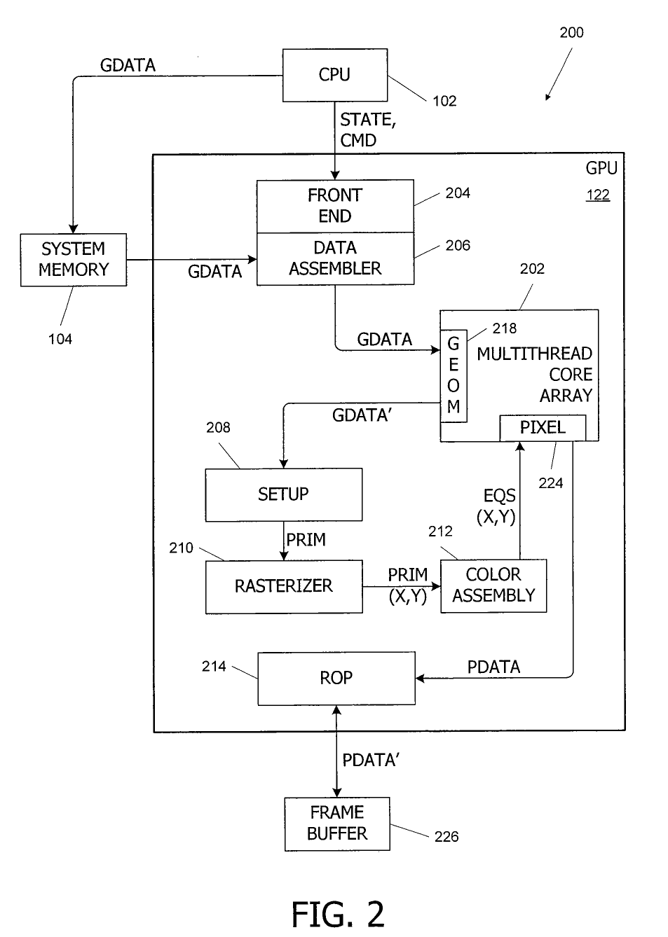

FIG. 2 is a block diagram of a rendering pipeline 200 that can be implemented in GPU 122 of FIG. 1 according to an embodiment of the present invention. In this embodiment, the rendering pipeline 200 is configured to receive the vertex data for the reference set of vertices from CPU 102. The rendering pipeline 200 may also receive the control data identifying the relative positions of additional vertices for a particle system. As noted above, a variety of other attributes for the additional vertices may also be included in the control data. The rendering pipeline 200 in this embodiment is implemented using an architecture in which any applicable vertex shader programs, geometry shader programs, and pixel shader programs are executed using the same parallel-processing hardware, referred to herein as a “multithreaded core array” 202. Multithreaded core array 202 is described further below.

In addition to multithreaded core array 202, rendering pipeline 200 includes a front end 204 and data assembler 206, a setup module 208, a rasterizer 210, a color assembly module 212, and a raster operations module (ROP) 214, each of which can be implemented using conventional integrated circuit technologies or other technologies.

Front end 204 receives state information (STATE), rendering commands (CMD), and geometry data (GDATA), e.g., from CPU 102 of FIG. 1. In some embodiments, rather than providing geometry data directly, CPU 102 provides references to locations in system memory 104 at which geometry data is stored; data assembler 206 retrieves the data from system memory 104. In some embodiments, the geometry data includes vertex data for the reference set of vertices, and also includes all or part of the associated control data for generating additional vertices for the particle system. In other embodiments, the state information may also include all or part of the control data. Apart from the inclusion of any control data, the state information, rendering commands, and geometry data may be of a generally conventional nature and may be used to define the desired rendered image or images, including geometry, lighting, shading, texture, motion, and/or camera parameters for a scene.

The geometry data may include vertex data for a set of vertices that are present in a scene, and the reference set of vertices may be included in the vertex data. The reference set of vertices may, for example, be a subset of the vertices in a particle system representing a “fuzzy” object. Alternatively, the reference set of vertices may define objects with well defined surfaces (e.g., water or other liquid, a table, a chair, a person or animal) that may be present in the scene. In other embodiments, the reference set of vertices need not be visible in a scene, instead merely serving as a location reference for the vertices to be generated for a particle system. Thus, the reference set of vertices may, but need not, be present in a scene or represent vertices of the particle system. In another embodiment, the geometry data may instead include vertex data for each of the vertices of a particle system, and a downstream processing unit (e.g., in the multithreaded core array 202) may identify a subset of the particle system vertices to form a reference set of vertices, and also create the control data for recreating the remainder of the particle system.

Some additional discussion regarding vertex data may be worthwhile. Both “fuzzy” and well-defined objects may be modeled as groups of points, lines, triangles and/or other polygons (often referred to as “primitives”) and, thus, these objects may be defined by reference to their vertices. For each vertex, a position is specified in an object coordinate system, representing the position of the vertex relative to the object being modeled. In addition to a position, each vertex may have various other attributes associated with it. In general, attributes of a vertex may include any property that is specified on a per-vertex basis; for instance, in some embodiments, the vertex attributes include scalar or vector attributes used to determine qualities such as the color, texture, transparency, lighting, shading, and animation of the vertex and its associated geometric primitives.

In one embodiment, the control data described above may be included or otherwise integrated into the per-vertex attributes. Thus, the rules for processing vertex data to generate additional vertices for a particle system may be included with the per-vertex attributes. The per-vertex attributes may, therefore, include rules for identifying positions of additional vertices for a particle system. The per-vertex attributes may also include attributes of the generated vertices (e.g., velocity (speed and direction), color, age, life cycle, transparency, mass, energy, size, shape, or particle density data) to be applied to the additional vertices created when the vertex data is decompressed. It is worth noting that the per-vertex attributes for vertices created in the geometry shader may be interpolated from the per-vertex data associated with the reference set (e.g., in a texture).

Primitives, as noted, may be characterized as a set or subset of vertices, and are generally defined by reference to their vertices. A single vertex may be included in any number of primitives. In some embodiments, each vertex is assigned an index (which may be any unique identifier), and a primitive may be defined by providing an ordered list of indices for the vertices making up that primitive. Other techniques for defining primitives (including conventional techniques such as triangle strips or fans) may also be used. Thus, the set of vertices associated with a primitive may make up the reference set of vertices. Alternatively, the reference set of vertices may include more than one primitive, or only a part of a primitive.

The state information and rendering commands define processing parameters and actions for various stages of rendering pipeline 200. Front end 204 may direct the state information and rendering commands via a control path (not explicitly shown) to other components of rendering pipeline 200. As noted above, state information may include control data. As is known in the art, these components may respond to received state information by storing or updating values in various control registers that are accessed during processing.

Front end 204 directs the geometry data (i.e., the vertex data for the reference subset and, perhaps, associated per-vertex attributes which may include control data) to data assembler 206. Data assembler 206 formats the geometry data and prepares it for delivery to a geometry module 218 in multithreaded core array 202.

Geometry module 218 directs programmable processing engines (not explicitly shown) in multithreaded core array 202 to execute vertex and/or geometry shader programs on the vertex data, with the programs being selected in response to the state information provided by front end 204. The vertex and/or geometry shader programs can be specified by the rendering application, and different shader programs can be applied to different vertices and/or primitives. The shader program(s) to be used can be stored in system memory or graphics memory and identified to multithreaded core array 202 via suitable rendering commands and state information as is known in the art. In some embodiments, vertex shader and/or geometry shader programs can be executed in multiple passes, with different processing operations being performed during each pass. Each vertex and/or geometry shader program may determine the number of passes and the operations to be performed during each pass. The number of passes may, in one embodiment, be specified or otherwise indicated in the control data. Vertex and/or geometry shader programs can implement algorithms using a wide range of mathematical and logical operations on vertices and other data, and the programs can include conditional or branching execution paths and direct and indirect memory accesses. The conditional or branching execution paths may be modified or otherwise dictated by the control data.

Vertex shader programs and geometry shader programs can be used to implement a variety of visual effects, including lighting and shading effects. For instance, in a simple embodiment, a vertex shader program transforms a vertex from its 3D object coordinate system to a 3D clip space or world space coordinate system. This transformation defines the relative positions of different objects in the scene. In one embodiment, the transformation can be programmed by including, in the rendering commands and/or data defining each object, a transformation matrix for converting from the object coordinate system of that object to clip space coordinates. The vertex shader program applies this transformation matrix to each vertex making up an object. More complex vertex shader programs can be used to implement a variety of visual effects, including lighting and shading, procedural geometry, and animation operations. In some embodiments, the vertex shader program receives the vertex data for the reference set of vertices, and also receives the control data associated therewith. The vertex shader program can then transform the set of vertices from its 3D object coordinate system to a 3D clip space or world space coordinate system, and perform other operations described above. The vertex shader may then forward the set of vertices (perhaps with the associated control data) to the geometry shader. The vertex shader program may also receive the additional generated vertices for the particle system in a later pass, and perform the operations described above thereon.

Geometry shader programs differ from vertex shader programs in that geometry shader programs may operate on groups of vertices (e.g., primitives) rather than individual vertices. Thus, in some instances, a geometry shader program creates new vertices and/or removes vertices or primitives from the set of objects being processed. In one embodiment, the geometry shader program is configured to receive and process the control data. In accordance with the parameters of the control data, the geometry shader may use the vertex data for the reference set of vertices to create additional vertices.

Thus, the geometry shader may utilize the vertex data for a reference set of vertices to generate additional vertices to enhance or create a particle system, in accordance with the control data. The geometry shader may, therefore, generate and identify the positions of additional vertices for a particle system, and compute or otherwise apply attributes to the generated vertices (e.g., velocity, color, age, life cycle, transparency, mass, energy, size, shape, or particle density attributes). In some embodiments, passes through a vertex shader program and a geometry shader program can be alternated to process the geometry data.

The geometry shader may compute attributes that vary with age of the generated vertices, or other time related metrics. Moreover, the geometry shader may compute attributes with random fluctuations of the position and other attributes of the additional vertices. The geometry shader may also calculate an effect of a collision between an object in a scene to be rendered and particles associated with the generated vertices, and modify the position of the generated vertices to reflect the collision. The control data may, thus, be reused on an inter-frame basis. For example, the control data associated with a reference set of vertices shown in a single frame may be reused in one or more later frames. The control data may, thus, be stored in memory 124 for reuse and further calculations.

As additional vertices are created by the geometry shader, they may be returned to the vertex shader programs for further processing. Thus, the vertex shader may perform various animation or other transformation operations on the generated particles (i.e., the particles defined in whole or in part by the generated vertices). In some embodiments, the geometry shader receives the reference set of vertices from the vertex shader; in other embodiments, other units may forward vertex data for the reference set to the geometry shader.

In some embodiments, vertex shader programs and geometry shader programs are executed using the same programmable processing engines in multithreaded core array 202. Thus, at certain times, a given processing engine may operate as a vertex shader, receiving and executing vertex shader program instructions and, at other times, the same processing engine may operate as a geometry shader, receiving and executing geometry shader program instructions. The processing engines can be multithreaded, and different threads executing different types of shader programs may be in flight concurrently in multithreaded core array 202.

After the vertex and/or geometry shader programs have executed, geometry module 218 passes the processed geometry data (GDATA′) to setup module 208. This GDATA′ may include vertex data for the additional vertices generated for the particle system. Thus, both the vertex data for the reference set of vertices and vertex data for the generated vertices may be forwarded. Setup module 208, which may be of generally conventional design, generates edge equations from the clip space or screen space coordinates of each set of vertices; the edge equations may be usable to determine whether a point in screen space is inside or outside the set of vertices.

Setup module 208 may provide each primitive (PRIM) to rasterizer 210. Note that in other embodiments, one or more sets of vertices may be provided to rasterizer 210 without a one-to-one correspondence with a particular primitive but, for purposes of discussion, assume that the set of vertices for a particular primitive (e.g., a primitive for the particle system) are provided together to rasterizer 210. Rasterizer 210, which may be of generally conventional design, determines which (if any) pixels are covered by the primitive, e.g., using conventional scan-conversion algorithms. As used herein, a “pixel” (or “fragment”) refers generally to a region in 2-D screen space for which a single color value is to be determined; the number and arrangement of pixels can be a configurable parameter of rendering pipeline 200 and might or might not be correlated with the screen resolution of a particular display device. As is known in the art, pixel color may be sampled at multiple locations within the pixel (e.g., using conventional supersampling or multisampling techniques), and in some embodiments, supersampling or multisampling is handled within the pixel shader.

After determining which pixels are covered, rasterizer 210 provides the primitive (PRIM), along with a list of screen coordinates (X,Y) of the pixels covered by the primitive, to a color assembly module 212. Color assembly module 212 associates the primitives and coverage information received from rasterizer 210 with attributes (e.g., color components, texture coordinates, surface normals) of the vertices of the primitive and generates plane equations (or other suitable equations) defining some or all of the attributes as a function of position in screen coordinate space.

Color assembly module 212 provides the attribute equations (EQS, which may include, e.g., the plane-equation coefficients A, B and C) for each primitive that covers at least one sampling location of a pixel and a list of screen coordinates (X,Y) of the covered pixels to a pixel module 224 in multithreaded core array 202. The functions of one or more of these units (setup 208, rasterizer 210, color assembly 212) may be performed by one of the processing engines of the multithreaded core array 202, or CPU 102, as well. Pixel module 224 directs programmable processing engines (not explicitly shown) in multithreaded core array 202 to execute one or more pixel shader programs on each pixel covered by the primitive, with the program(s) being selected in response to the state information provided by front end 204. Pixel shader programs can be used to implement a variety of visual effects, including lighting and shading effects, reflections, texture blending, procedural texture generation, and so on. Numerous examples of such per-pixel operations are known in the art and a detailed description is omitted as not being critical to understanding the present invention. Pixel shader programs can implement algorithms using a wide range of mathematical and logical operations on pixels and other data, and the programs can include conditional or branching execution paths and direct and indirect memory accesses. The pixel shader programs may be executed according to the control data.

Pixel shader programs may generate texture data to be applied to one or more vertices. A pixel shader program may, therefore, integrate or otherwise associate control data with a set of vertices, and pass this reference set of vertices through the vertex and/or geometry shader program again.

In one embodiment, pixel shader programs are advantageously executed in multithreaded core array 202 using the same programmable processing engines that also execute the vertex and/or geometry shader programs. Thus, at certain times, a given processing engine may operate as a vertex shader, receiving and executing vertex shader program instructions; at other times, the same processing engine may operate as a geometry shader, receiving and executing geometry shader program instructions; and at still other times, the same processing engine may operate as a pixel shader, receiving and executing pixel shader program instructions. It will be appreciated that the multithreaded core array can provide natural load-balancing: where the application is geometry intensive (e.g., many small primitives), a larger fraction of the processing cycles in multithreaded core array 202 will tend to be devoted to vertex and/or geometry shaders, and where the application is pixel intensive (e.g., fewer and larger primitives shaded using complex pixel shader programs with multiple textures and the like), a larger fraction of the processing cycles will tend to be devoted to pixel shaders.

Once processing for a pixel or group of pixels is complete, pixel module 224 provides the processed pixels (PDATA) to ROP 214. ROP 214, which may be of generally conventional design, integrates the pixel values received from pixel module 224 with pixels of the image under construction in frame buffer 226, which may be located, e.g., in graphics memory 124. Once the image is complete, frame buffer 226 can be scanned out to a display device and/or subjected to further processing. It will be appreciated that the rendering pipeline described herein is illustrative and that variations and modifications are possible. The pipeline may include different units from those shown and the sequence of processing events may be varied from that described herein. Further, multiple instances of some or all of the modules described herein may be operated in parallel.

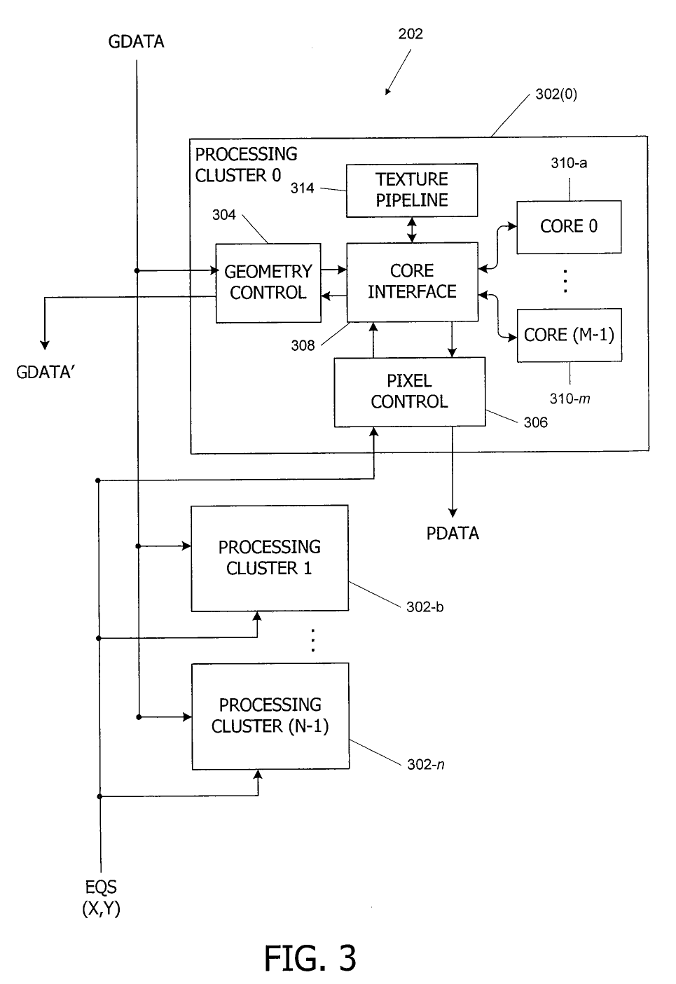

In one embodiment, multithreaded core array 202 provides a highly parallel architecture that supports concurrent execution of a large number of instances of vertex, geometry, and/or pixel shader programs in various combinations. FIG. 3 is a block diagram of multithreaded core array 202 according to an embodiment of the present invention.

In this embodiment, multithreaded core array 202 includes some number (N) of processing clusters 302. Herein, multiple instances of like objects are denoted with reference numbers identifying the object and parenthetical numbers identifying the instance where needed. Any number N (e.g., 1, 4, 8, or any other number) of processing clusters may be provided. In FIG. 3, one processing cluster 302 is shown in detail; it is to be understood that other processing clusters 302 can be of similar or identical design.

Each processing cluster 302 includes a geometry controller 304 (implementing geometry module 218 of FIG. 2) and a pixel controller 306 (implementing pixel module 224 of FIG. 2). Geometry controller 304 and pixel controller 306 each communicate with a core interface 308. Core interface 308 controls a number (M) of cores 310 that include the processing engines of multithreaded core array 202. Any number M (e.g., 1, 2, 4 or any other number) of cores 310 may be connected to a single core interface. Each core 310 is advantageously implemented as a multithreaded execution core capable of supporting a large number (e.g., 100 or more) of concurrent execution threads (where the term “thread” refers to an instance of a particular program executing on a particular set of input data), including a combination of vertex threads, geometry threads, and pixel threads.

Core interface 308 also controls a texture pipeline 314 that may be shared among cores 310. Texture pipeline 314, which may be of generally conventional design, advantageously includes logic circuits configured to receive texture coordinates, to fetch texture data corresponding to the texture coordinates from memory, and to filter the texture data according to various algorithms.

In operation, data assembler 206 (FIG. 2) provides geometry data GDATA (e.g., vertex data for a set of reference vertices and, perhaps, associated control data) to processing clusters 302. In one embodiment, data assembler 206 divides the incoming stream of geometry data into portions and selects, e.g., based on availability of execution resources, which of processing clusters 302 is to receive the next portion of the geometry data. That portion (e.g., a subset of the vertices of a primitive or group of primitives) is delivered to geometry controller 304 in the selected processing cluster 302.

Geometry controller 304 forwards received data to core interface 308, which loads the vertex data into a core 310, then instructs core 310 to launch the appropriate vertex shader program. Upon completion of the vertex shader program, core interface 308 signals geometry controller 304. If a geometry shader program is to be executed, geometry controller 304 instructs core interface 308 to launch the geometry shader program. Control data may direct or otherwise indicate to the geometry controller 304 whether a geometry or vertex shader program should be launched, or if the programs are completed. In some embodiments, the processed vertex data is returned to geometry controller 304 upon completion of the vertex shader program, and geometry controller 304 instructs core interface 308 (e.g., according to control data) to reload the data before executing the geometry shader program. Any vertex data for new vertices created by the geometry shader (e.g., the vertices generated for the particle system) may be returned to the vertex shader for further execution (e.g., according to control data). After completion of the vertex shader program and/or geometry shader programs, geometry controller 304 provides the processed geometry data (GDATA′) to setup module 208 of FIG. 2.

At the pixel stage, color assembly module 212 may divide the incoming stream of coverage data into portions and select, e.g., based on availability of execution resources or the location of the primitive(s) in-screen coordinates, which of processing clusters 302 is to receive the next portion of the data. That portion is delivered to pixel controller 306 in the selected processing cluster 302.

Pixel controller 306 delivers the data to core interface 308, which loads the pixel data into a core 310, then instructs the core 310 to launch the pixel shader program. It will be appreciated that the multithreaded core array described herein is illustrative and that variations and modifications are possible. Any number of processing clusters may be provided, and each processing cluster may include any number of cores. In some embodiments, shaders of certain types may be restricted to executing in certain processing clusters or in certain cores; for instance, geometry shaders might be restricted to executing in core 310(0) of each processing cluster. Such design choices may be driven by considerations of hardware size and complexity versus performance, as is known in the art. The multithreaded core array can also be leveraged to perform general-purpose computations that might or might not be related to rendering images. In one embodiment, any computation that can be expressed in a data-parallel decomposition (e.g., creating vertex data for the reference set of vertices, creating control data to generate vertices and associated attributes for a particle system, etc.) can be handled by the multithreaded core array as an array of threads executing in a single core. Results of such computations can be written to the frame buffer and read back into system memory.

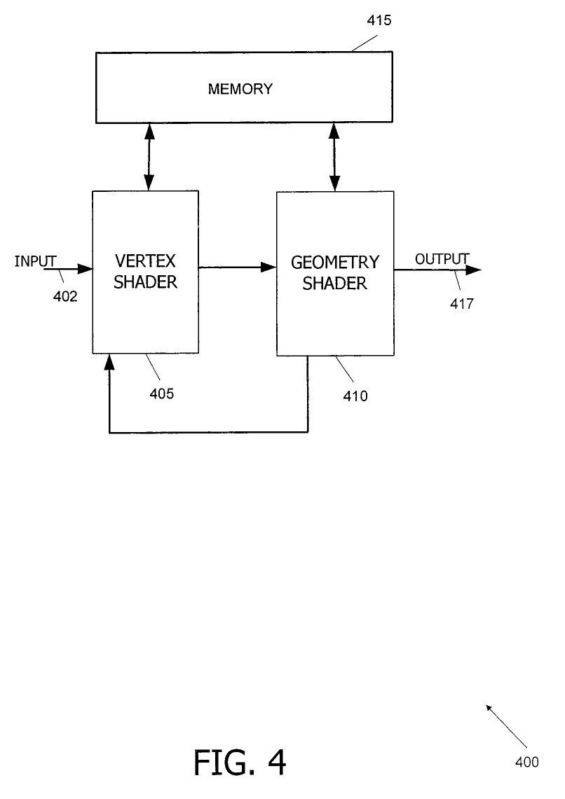

FIG. 4 is a block diagram of certain components 400 of a rendering pipeline, including a vertex shader 405, geometry shader 410 and memory 415. These components may, for example, be included in the rendering pipeline 200 implemented in GPU 122 of FIG. 1. They may be implemented using one or more shared processing engines in the multithreaded core array 202 of FIG. 3. Alternatively, they may be implemented as one, or more, Application Specific Integrated Circuits (ASICs) adapted to perform a subset of the applicable functions in hardware. In other embodiments, other types of integrated circuits may be used (e.g., Structured/Platform ASICs, Field Programmable Gate Arrays (FPGAs) and other Semi-Custom ICs), which may be programmed in any manner known in the art. Each may also be implemented, in whole or in part, with instructions embodied in a computer-readable medium, formatted to be executed by one or more general or application specific processors.

In one embodiment, vertex data 402 for a reference set of vertices is received by the vertex shader 405. The vertex shader 405 performs any applicable transformations as described above. The vertex shader 405 may also perform lighting and shading, procedural geometry, and animation operations, e.g., by accessing memory 415 to retrieve vertex texture data. The vertex shader 405 may also receive, and forward, control data. The geometry shader 410 is configured to receive the vertex data from the vertex shader 405 and compute additional vertices for a particle system utilizing at least part of that vertex data. In one embodiment, the geometry shader 410 also receives control data from the vertex shader 405 which includes information to compute positions of the additional vertices generated for the particle system (and, perhaps, attributes of the additional vertices). In another embodiment, the control data is accessed from memory, and is not received from the vertex shader 105.

The geometry shader 410, therefore, is configured to use the set of control data in conjunction with the vertex data to generate additional vertices for a particle system. The control data may be used by the geometry shader to identify the position, velocity (speed and direction), color, age, life cycle, transparency, mass, energy, size, shape, previous position, previous color, or particle density associated with generated vertices. Other attributes may be used as well.

Particles may be created in a variety of ways from the reference set of vertices. For example, particles may be created with reference to a single vertex or set of vertices. Alternatively, particles may be created on or off the surface of various 2D primitives, on or off the surface, or within or outside the volume, of a 3D primitive, and in a variety of other ways as evident to those skilled in the art.

The control data may include a stochastic process causing random fluctuations of the position and other attributes of the additional vertices. Any of the attributes listed above may be randomized, and the stochastic process may be applied globally or selectively. The control data may include rules to be applied under only certain conditions, to certain subsets of vertices, or at certain times. For example, the set of control data may identify a first subset of the additional vertices which is to be produced to varying levels of density in different circumstances. In another embodiment, the set of control data identifies attributes to be applied only to a subset of the additional computed vertices, and not applied to the reference set of vertices. The geometry shader may be configured to calculate an effect of a collision between an object in a scene to be rendered and particles associated with the generated vertices, and modify the position of the generated vertices to reflect the collision. Other effects of environmental conditions on a particle may also be calculated in the geometry shader, such as gravity, magnetic fields, wind gusts, and the positions and attributes of the additional vertices for the particle system may be modified accordingly.

Therefore, the geometry shader may process control data for use on an inter-frame basis. For example, the control data associated with a reference set of vertices shown in a single frame may be reused in one or more later frames. The control data may, thus, be stored in memory 415 for reuse. A geometry shader may reuse the same set of control data to generate vertices with positions and attributes varying over time (e.g., between frames). A geometry shader may similarly reuse the same set of control data for generating and/or terminating (e.g., according to age and life cycle extinction) vertices in later frames.

Once the geometry shader 410 has computed additional vertices for the particle system, the vertex data for the additional vertices may be returned to the vertex shader 405 for further execution (e.g., according to control data). The data produced by the second pass through the vertex shader 405 may then be processed further by the geometry shader 410 or may be otherwise forwarded (e.g., according to control data). Thus, the rules data may specify or otherwise indicate the number of passes through a vertex shader 405 or geometry shader 410. Vertex data for the particle system 417 may then be forwarded to a pixel shader.

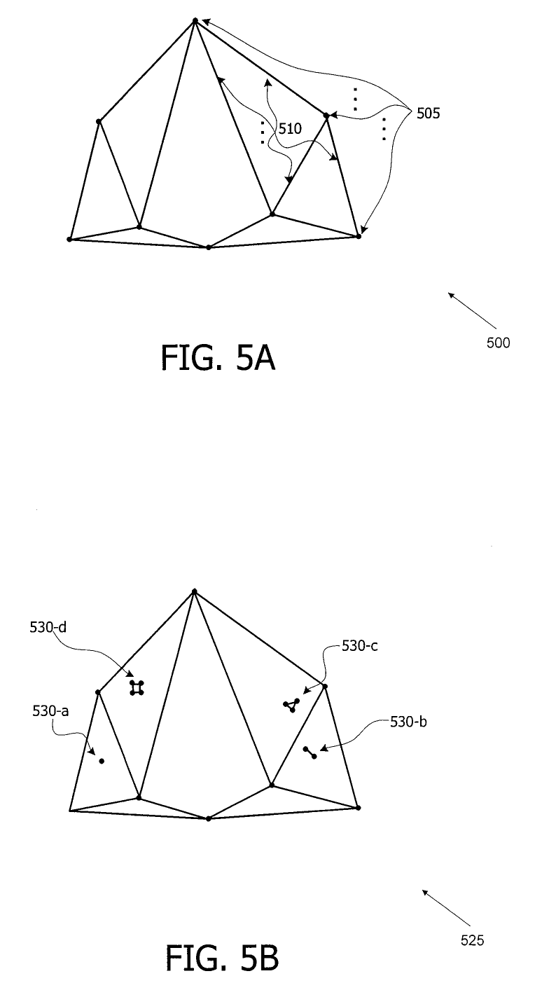

FIG. 5A is diagram representing of 3D model 500 defined by vertices 505 and associated line segments 510. In this embodiment, the vertices (or any subset thereof) of the model 500 may represent the reference set of vertices. In some embodiments, vertex data representing the reference set is received by a geometry shader (e.g., the geometry shader of FIG. 4). Control data associated with the reference set of vertices may be received concurrently by the geometry shader.

FIG. 5B is a representation of a larger set of vertices and their associated line segments 525, illustrating a basic example of the generation of additional vertices 530 using a reference set of vertices from the model 500. The additional vertices 530 form at least a portion of a particle system. In this embodiment, the reference set also represents a portion of the particle system (e.g., this particle system could represent the fire at a campfire). However, in other embodiments, the reference set need not be part of the particle system. The control data indicates the positions of the additional vertices 530 relative to one or more of the reference set of vertices 505. The additional vertices may, for example, be on the surface of the 3D control mesh, within the volume thereof, or independent thereof. As is illustrated, the particles of the particle system may each be a single vertex 530-a, two vertices connected by a line segment 530-b, three vertices forming a triangle 530-c, or four or more vertices forming other polygons 530-d. The control data is used to identify the position of the additional vertices 530 relative to one or more of the reference set of vertices. The control data may also be used to compute additional attributes of the generated vertices, in any manner described above.

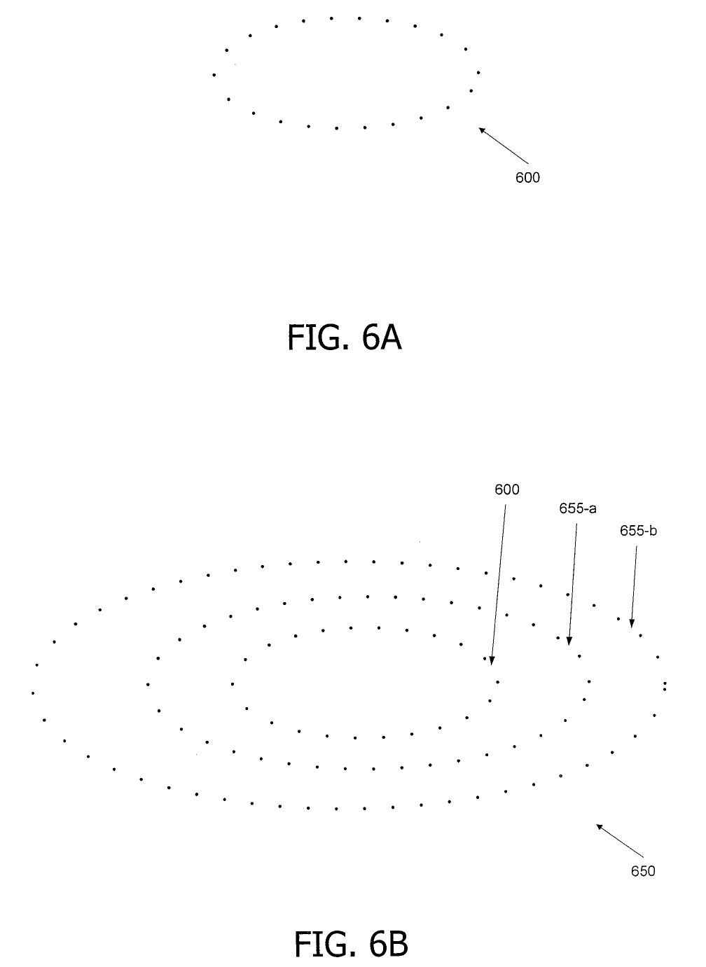

FIG. 6A is a diagram representing a reference set of vertices 600. In this embodiment, the reference set is in a circular pattern on a two dimensional plane. By way of example, explosions may at least in part be represented by series of vertices in circles, using a particle system. Vertex data representing the reference set may be received by a geometry shader (e.g., the geometry shader of FIG. 4). Control data associated with the reference set of vertices may be received by the geometry shader, for example, within the per-vertex attributes for the reference set.

FIG. 6B is a representation of a larger set of vertices 650, illustrating another example of the generation of additional vertices 655 using a reference set of vertices for a particle system. The additional vertices 655 form at least a portion of a particle system. In this embodiment, the reference set also represents a portion of the particle system (e.g., this particle system could represent an outer ring of an explosion). However, again note that in other embodiments the reference set need not be part of the particle system. The control data may indicate the positions of the additional vertices 655 relative to one or more of the reference set of vertices 600. The additional vertices in this embodiment are in the plane of the reference set, and outside its boundary. However, in other embodiments, the additional vertices could be inside the boundary of the reference set, or outside the plane (e.g., for a more volumetric effect). The generated vertices, and the reference set may each be part of different frames. For example, the reference set of vertices 600 might be part of a first frame, the next circle of vertices 655-a might be part of a second frame, and the next circle of vertices 655-b might be part of a third. The control data may provide information on how a particle system evolves between frames. The control data is used to identify the position of the generated vertices 655 relative to one or more of the reference set, and may also be used to compute additional attributes of the generated vertices 655.

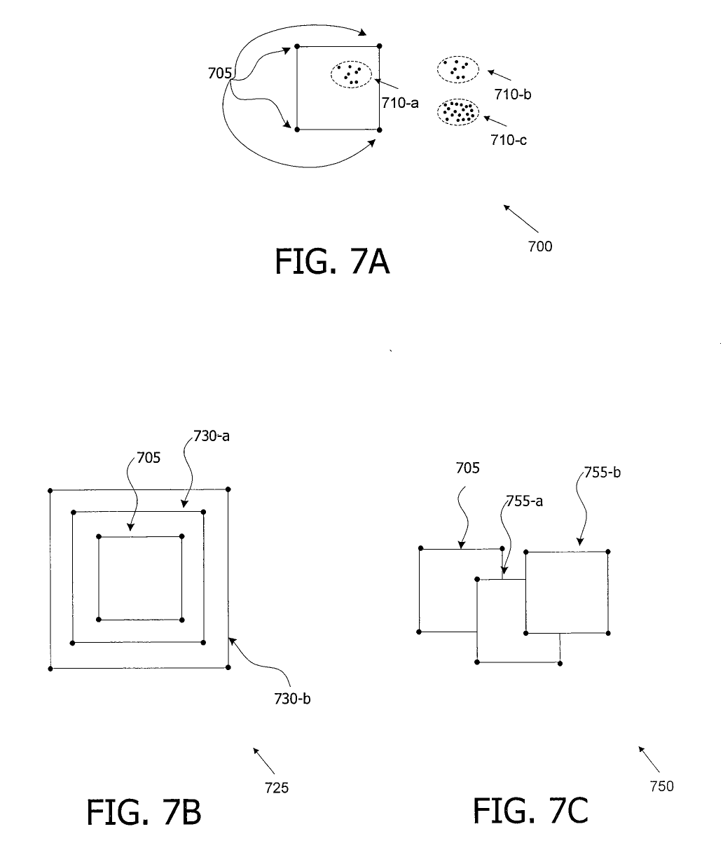

FIG. 7A is a diagram representing a set of vertices 700, including a reference set of vertices 705 and additional sets of generated vertices 710. In this embodiment, the reference set includes four vertices 705, which with their associated line segments form a control mesh. FIG. 7A illustrates how simpler sets of vertex data might be associated with more complex control data, with rules for generating more complex particles systems. As noted above, the vertex data and control data associated with the reference set may be received by a geometry shader (e.g., the geometry shader of FIG. 4).

The control data may be processed to identify the position of generated vertices 710 relative to the reference set 705, and identify other attributes to be associated with generated vertices 710. Thus, the control data in this embodiment guides the geometry shader to generate vertices to form a particle system. The control data may indicate that a first set of generated vertices 710-a be located on a surface of the control mesh. The control data may indicate that a second set of vertices 710-b be located outside of the control mesh, and yet otherwise have the same attributes and spacing as the first set 710-a. A third set of vertices 710-c may also be located outside of the control mesh, and have a more dense grouping of vertices. The particles generated using the set of control data may be displayed over a number of frames, in accordance with the parameters set forth in the control data. Those skilled in the art will recognize that the above examples represent but a sampling of the alternative forms of control data.

However, it is worth noting that in some instances, the number of vertices that may be created in a geometry shader are limited. There may also be computational reasons to utilize additional sets of reference vertices, each associated with less control data. Those skilled in the art will recognize the tradeoffs. FIG. 7B illustrates a set of vertices 725 disclosing one such embodiment. In FIG. 7B, concentric meshes including two new reference sets of vertices 730 surround the original reference set 705. In this manner, control data to generate additional vertices may be distributed between more control meshes. This may, in some embodiments, result is computational savings. FIG. 7C illustrates a set of vertices 750 disclosing another such embodiment. In FIG. 7C, overlapping meshes including two new reference sets of vertices 755 overlay the original reference set 705. In this manner, control data to generate additional vertices may be distributed between more control meshes in different planes. This may, in some embodiments, result in computational savings. Different reference set positioning (e.g., via concentric, overlapping, or intersecting meshes) can be used to create various layering and density effects.

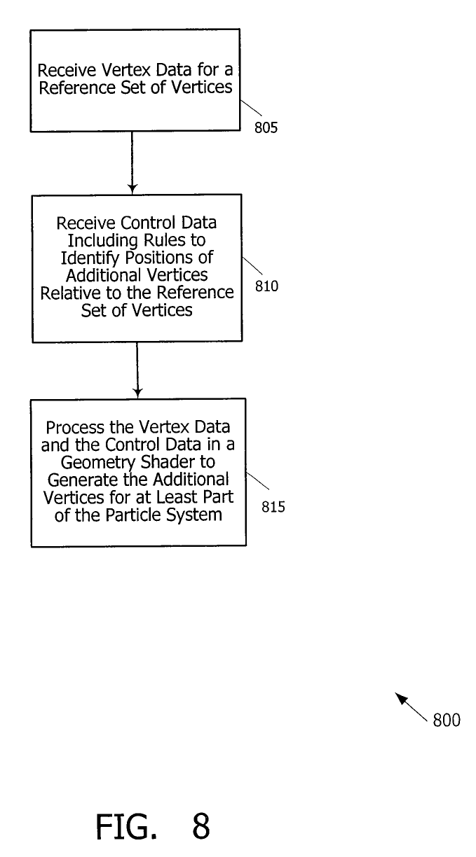

FIG. 8 is a flowchart illustrating a process 800 for processing data using a geometry shader to generate vertices for a particle system according to various embodiments of the present invention. The process may, for example, be performed in whole or in part by the rendering pipeline 200 of FIG. 2. At block 805, vertex data for a reference set of vertices is received. At block 810, control data including rules to identify positions of additional vertices relative to the reference set of vertices is received. At block 815, a geometry shader (e.g., the geometry shader 410 of FIG. 4) processes the vertex data and the control data to generate the additional vertices for a particle system.

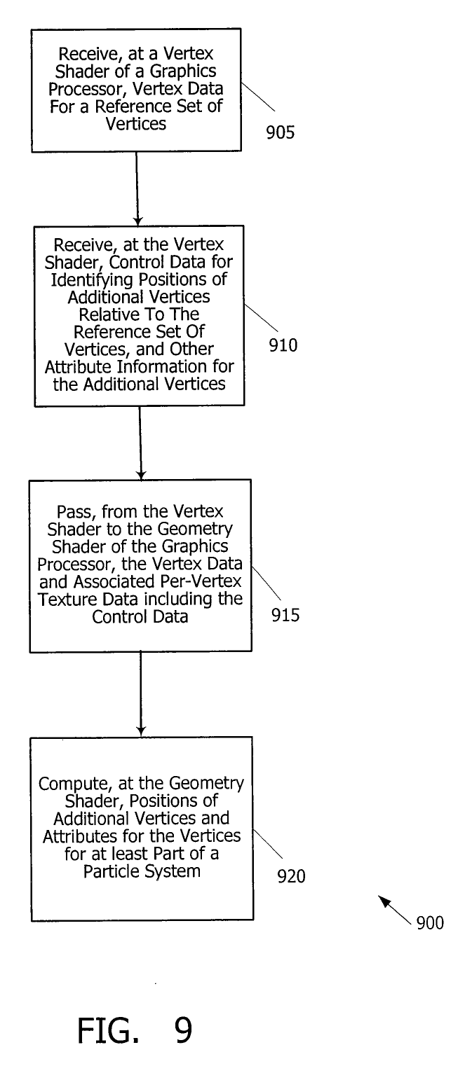

FIG. 9 is a flowchart illustrating a process 900 of computing additional vertices and attributes for a particle system using a geometry shader according to various embodiments of the present invention. As above, the process may be performed in whole or in part by the rendering pipeline 200 of FIG. 2. At block 905, vertex data is received by a vertex shader (e.g., the vertex shader 405 of FIG. 4) for a reference set of vertices. At block 910, the vertex shader receives control data that identifies positions of additional vertices relative to one or more of the reference set of vertices. The control data also includes other attribute information for the additional vertices (e.g., velocity, color, age, life cycle, transparency, mass, energy, size, shape, or particle density data).

At block 915, the vertex data and the per-vertex texture data are passed to the geometry shader (e.g., the geometry shader 410 of FIG. 4). The control data is integrated into or otherwise associated with the per-vertex texture data, and is thereby passed to the geometry shader. At block 920, the geometry shader computes positions for the additional vertices, and attributes for the vertices, for at least part of a particle system.

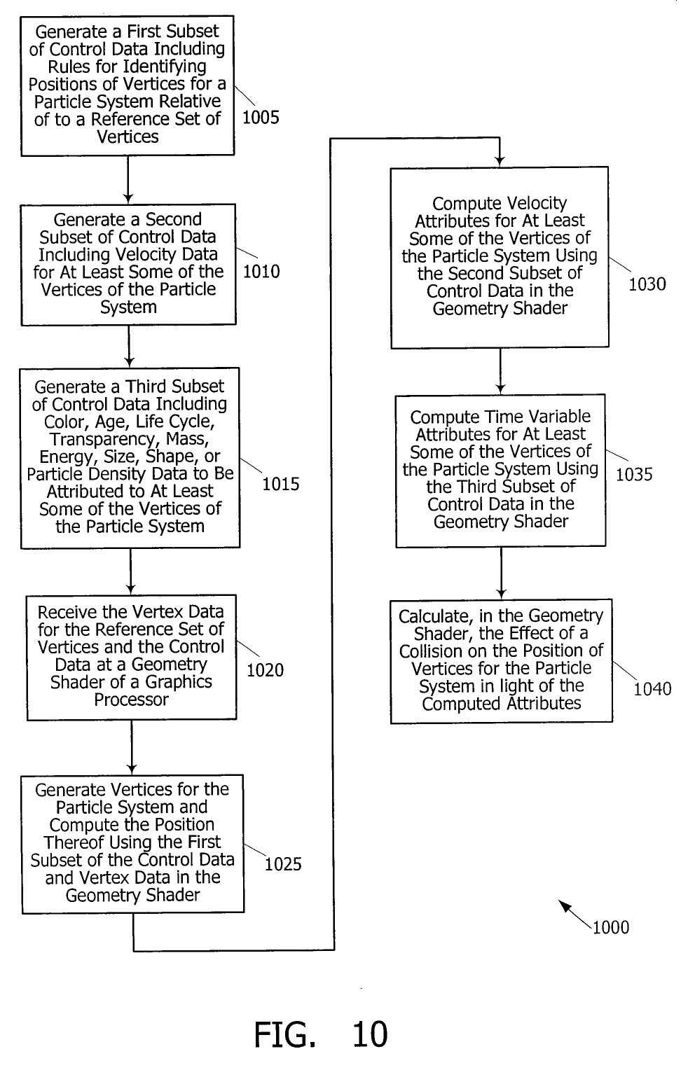

FIG. 10 is a flowchart illustrating an alternative process 1000 of computing additional vertices and attributes for a particle system using a geometry shader according to various embodiments of the present invention. The process may, for example, be performed in whole or in part by the components of the computer system 100 of FIG. 1. At block 1005, a first subset of control data is generated, including rules for identifying positions of vertices for a particle system relative to one or more of a reference set of vertices. At block 1010, a second subset of control data is generated including velocity data for at least some of the vertices of the particle system. At block 1015, a third subset of control data is generated. The third subset includes color, age, life cycle, transparency, mass, energy, size, shape, or particle density data to be attributed to at least some of the vertices of the particle system.

At block 1020, a geometry shader (e.g., the geometry shader 410 of FIG. 4) receives the vertex data for the reference set of vertices, and also receives the control data. At block 1025, the geometry shader generates vertices for the particle system, computing the position of the generated vertices using the first subset of the control data and the vertex data.

At block 1030, the geometry shader computes velocity attributes for at least some of the vertices of the particle system using the second subset of control data. At block 1035, the geometry shader computes time variable attributes for at least some of the vertices of the particle system using the third subset of control data. At block 1040, the geometry shader calculates the effect of a collision on the position of vertices for the particle system in light of the computed attributes. The geometry shader may associate any computed attributes with the applicable vertices for the particle system in any manner known in the art.

It should be noted that the methods, systems and devices discussed above are intended merely to be exemplary in nature. It must be stressed that various embodiments may omit, substitute, or add various procedures or components as appropriate. For instance, it should be appreciated that in alternative embodiments, the methods may be performed in an order different from that described, and that various steps may be added, omitted or combined. Also, features described with respect to certain embodiments may be combined in various other embodiments. Different aspects and elements of the embodiments may be combined in a similar manner. Also, it should be emphasized that technology evolves and, thus, many of the elements are exemplary in nature and should not be interpreted to limit the scope of the invention.

Specific details are given in the description to provide a thorough understanding of the embodiments. However, it will be understood by one of ordinary skill in the art that the embodiments may be practiced without these specific details. Also, well-known circuits, processes, algorithms, structures, and techniques have been shown without unnecessary detail in order to avoid obscuring the embodiments.

It is noted that the embodiments may be described as a process which is depicted as a flowchart or a block diagram. Although these may describe the operations as a sequential process, many of the operations can be performed in parallel or concurrently. In addition, the order of the operations may be re-arranged. A process may be terminated when its operations are completed, but could have additional steps not included in the figure.

Moreover, as disclosed herein, the term “memory” may represent one or more devices for storing data, including read only memory (ROM), random access memory (RAM), magnetic RAM, core memory, magnetic disk storage mediums, optical storage mediums, flash memory devices or other machine readable mediums for storing information. The term “machine-readable medium” includes, but is not limited to, portable or fixed storage devices, optical storage devices, wireless channels, a sim card, other smart cards, and various other mediums capable of storing, containing or carrying instructions or data.

Furthermore, embodiments may be implemented by hardware, software, firmware, middleware, microcode, hardware description languages, or any combination thereof. When implemented in software, firmware, middleware or microcode, the program code or code segments to perform the necessary tasks may be stored in a machine readable medium such as a storage medium. Processors may perform the necessary tasks.

Having described several embodiments, it will be recognized by those of skill in the art that various modifications, alternative constructions, and equivalents may be used without departing from the spirit of the invention. For example, the above elements may merely be a component of a larger system, wherein other rules may take precedence over or otherwise modify the application of the invention. Also, a number of steps may be required before the above elements are considered. Accordingly, the above description should not be taken as limiting the scope of the invention, which is defined in the following claims.

What is claimed is:

1. A graphics processor comprising:
one or more upstream processing units configured to pass vertex data for a first set of vertices; and
a geometry shader, coupled with the one or more upstream processing units, and configured to:
receive the vertex data;
receive control data, the control data including rules for identifying positions of additional vertices relative to one or more of the first set of vertices; and
generate the additional vertices using the vertex data and the control data to create at least part of a particle system.

2. The processor of claim 1, wherein the one or more upstream processing units comprise a vertex shader.

3. The processor of claim 1, wherein,
the control data includes additional attribute information for the generated vertices; and
the geometry shader associates attributes identified in the attribute information with at least a subset of the generated vertices.

4. The processor of claim 3, wherein the additional attribute information comprises velocity data including speed and direction attributed to at least a subset of the generated vertices.

5. The processor of claim 3, wherein the attribute information comprises color, age, life cycle, transparency, mass, energy, size, shape, or particle density data for a subset of the generated vertices.

6. The processor of claim 3, wherein,
the attribute information identifies attributes varying with age of the generated vertices; and
the geometry shader is configured to identify attributes from the control data based at least in part on the age associated with the generated vertices.

7. The processor of claim 1, wherein the one or more upstream processing units are further configured to provide the control data with vertex texture data.

8. The processor of claim 1, wherein the geometry shader is configured to compute attributes for the generated vertices using the control data, wherein the attributes are variable dependent on a time related metric.

9. The processor of claim 1, wherein the geometry shader is further configured to:
calculate an effect of a collision between an object in a scene to be rendered and particles associated with the generated vertices; and
modifies the position of the generated vertices to reflect the collision.

10. The processor of claim 1, wherein:
the first set of vertices comprises a primitive in a first shape; and
the generated vertices comprise at least one of a set of points, lines, triangles, quadrilaterals, or other polygons in a second shape different than the first shape.

11. The processor of claim 1, wherein the first set of vertices comprises at least a part of the particle system.

12. The processor of claim 1, wherein the particle system illustrates fire, an explosion, smoke, a waterfall, flowing water, blood, other liquid, sparks, falling leaves, a tree, a flock, clouds, fog, mist, rain, snow, dust, or other fuzzy objects.

13. A graphics processor comprising:
a vertex shader configured to:
receive vertex data for a first set of vertices;
receive control data including rules associated with generating additional vertices for a particle system using the first set of vertices; and
pass the vertex data and the control data; and
a geometry shader, coupled with the vertex shader, and configured to:
receive the vertex data and the control data; and
process the vertex data and the control data to create at least part of the particle system.

14. The processor of claim 13, wherein,
the control data comprises rules for identifying positions of the additional vertices relative to one or more of the first set of vertices; and
the geometry shader is further configured to process the vertex data and the control data to compute the positions of the additional vertices.

15. The processor of claim 13, wherein the control data comprises velocity attributes of the additional vertices.

16. A method of processing vertex data, the method comprising;
receiving vertex data for a first set of vertices;
receiving control data, the control data including rules to identify positions of additional vertices relative to one or more of the first set of vertices; and
processing the vertex data and the control data in a geometry shader to generate the additional vertices for at least a part of the particle system.

17. The method of claim 16, further comprising:
including additional attribute information for the generated vertices in the control data; and
computing attributes for the generated vertices in the geometry shader using the additional attribute information.

18. The method of claim 16, further comprising:
integrating the control data with per-vertex texture data; and
passing the per-vertex texture data with the integrated control data to the geometry shader for processing.

19. The method of claim 16, further comprising:
rendering the particle system while the first set of vertices are invisible in the rendered scene.

20. The method of claim 17, further comprising:
generating the control data including the rules and the attribute information;
forwarding the control data to the geometry shader.
